(19) United States
(12) Patent Application Publication
(10) Pub. No.: US 2026/0268804 A1
(43) Pub. Date: Sep. 10, 2026

(54) ANATOMIC SIMULACRA HAVING PREDEFINED FRACTURE/TEAR PATTERNS, AND CAST ANATOMIC SIMULACRA WITH PRETENSIONED FIBRAL ELEMENTS

(71) Applicant: Arthrex, Inc., Naples, FL (US)

(72) Inventors: David Knopf, Bonita Springs, FL (US); Shervin Kazemi, Naples, FL (US); Benjamin D. Bernarding, Naples, FL (US); Michael Bonaldi, Sarasota, FL (US); Gage Weimer, Ruskin, FL (US); Ryan Westbrook, Naples, FL (US); David Yang, Naples, FL (US); Nick Metcalfe, Bonita Springs, FL (US)

(73) Assignee: Arthrex, Inc., Naples, FL (US)

(21) Appl. No.: 19/559,782

(22) Filed: Mar. 6, 2026

Related U.S. Application Data
(60) Provisional application No. 63/768,390, filed on Mar. 7, 2025.

(51) Int. Cl. G09B 23/34

(52) U.S. Cl. CPC G09B 23/34

(57) ABSTRACT

A 3D printed anatomic simulacra includes an inner structure, an exterior shell surrounding the inner structure and the core, at least one fragmented exterior shell piece adjacent to the exterior shell, a removable matrix extending between the inner structure and the core, and support structures embedded within the removable matrix, the plurality of support structures extending throughout the inner structure. The removable matrix is configured to be removed from the 3D printed anatomic simulacra before a simulated medical procedure. Another 3D printed anatomic simulacra includes a flexible connective tissue connecting at least two components, the flexible connective tissue defining voids, wherein the plurality of voids are configured to sequentially tear under an applied load, thereby simulating a predefined tear classification. Another anatomic simulacra includes pretensioned fibral elements embedded within a matrix.

### CROSS-REFERENCE TO RELATED APPLICATION

This application priority to and the benefit of U.S. Provisional Application No. 63/768,390 filed on Mar. 7, 2025. The disclosure of the above application is incorporated herein by reference.

### BACKGROUND

The present disclosure relates to surgical systems, devices and methods for planning and implementing surgical procedures utilizing physical models of anatomy.

Deformities may form along various bones and joints of the human musculoskeletal system. Further, soft tissue, such as a ligament or tendon, may become detached from a bone. Surgery may be required to remove deformities from bones and joints, replace entire joints, and/or reattach soft tissue to the bone to promote healing. Surgeons may prepare for surgery by performing a procedure on a cadaveric specimen.

### SUMMARY

This section provides a general summary of the disclosure and is not a comprehensive disclosure of its full scope or all of its features.

The materials and synthetic components disclosed herein may be utilized to establish physical anatomical models of anatomy. The components may be 3D printed or constructed using additive manufacturing techniques.

### Sequential Fracture

In one form, a 3D printed anatomic simulacra comprises a core, an inner structure disposed proximate an upper portion of the core, an upper exterior shell surrounding the inner structure and the upper portion of the core, a lower exterior shell surrounding a lower portion of the core, at least one fragmented exterior shell piece extending between the upper exterior shell and the lower exterior shell, a removable matrix extending between the inner structure and the core, a plurality of support structures embedded within the removable matrix, the plurality of support structures extending throughout the inner structure, wherein the removable matrix is configured to be removed from the 3D printed anatomic simulacra before a simulated medical procedure.

In variations of this 3D printed anatomic simulacra, which may be implemented individually or in any combination: the core is configured to simulate marrow; the core is a porous material; the inner structure is configured to simulate a cancellous; the cancellous is at least one of a subchondral cancellous, an epiphysis cancellous, or a metaphysis cancellous; the inner structure is a porous material; the upper exterior shell, the lower exterior shell, and the at least one fragmented exterior shell piece are configured to simulate cortical bone; the at least one fragmented exterior shell piece comprises a plurality of fragmented exterior shell pieces configured to simulate a multifragmentary fracture; the at least one fragmented exterior shell piece is configured to simulate a partial articular fracture; the plurality of fragmented exterior shell pieces are configured to simulate a fragmentary fracture; the plurality of fragmented exterior shell pieces are configured to simulate a complete articular fracture; the plurality of support structures comprise a material having a modulus of elasticity higher than a modulus of the inner structure and a modulus of the core; the plurality of support structures are disposed in zones; the plurality of support structures extend at different angles within each of the zones; and the plurality of support structures define different cross-sectional areas and lengths.

In another variation, a 3D printed anatomic simulacra comprises an inner structure, an exterior shell surrounding the inner structure, at least one fragmented exterior shell piece adjacent to the exterior shell, a removable matrix extending throughout the inner structure, and a plurality of support structures embedded within the removable matrix, the plurality of support structures extending throughout the inner structure, wherein the removable matrix is configured to be removed from the 3D printed anatomic simulacra before a simulated medical procedure.

### Sequential Tear

In another form, a 3D printed anatomic simulacra comprises a flexible connective tissue connecting at least two components, the flexible connective tissue defining a plurality of voids extending from a proximal end portion to a distal end portion of the at least two components, wherein the plurality of voids are configured to sequentially tear under an applied load, thereby simulating a predefined tear classification.

In variations of this 3D printed anatomic simulacra, which may be implemented individually or in any combination: the flexible connective tissue comprises an elastomeric material; the at least two components are configured to simulate anatomical bones; the anatomical bones comprise the 3D printed anatomic simulacra according to any of the variations illustrated and described herein; the flexible connective tissue is configured to simulate ligaments; the at least two components are configured to simulate an anatomical bone and muscle, respectively, and the flexible connective tissue is configured to simulate tendons; and the plurality of voids define perforations.

### Pretensioned Cast Fibers

In still another form of the present disclosure, an anatomic simulacra comprises a plurality of fibral elements embedded within a matrix, the anatomic simulacra manufactured by a process of: placing the plurality of fibral elements under tension within a core of a mold; filling the core of the mold with a matrix; curing the matrix; and releasing the plurality of fibral elements and the matrix from the mold. The plurality of fibral elements being under tension limits displacement of the anatomic simulacra during use.

In variations of this anatomic simulacra, which may be implemented individually or in any combination: the matrix comprises a composite material having a durometer proximate an exterior portion that is higher than a durometer proximate an interior portion; the fibral elements comprise a textile material; and the fibral elements comprise at least one of a nylon material and a polyester material.

Further areas of applicability will become apparent from the description provided herein. It should be understood that the description and specific examples are intended for purposes of illustration and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1A is a schematic illustration of a surgical environment.

FIG. 1B is a schematic illustration of a surgical system.

FIG. 1C is a schematic view of a Danis-Weber fracture, to which the teachings of the present disclosure may be applied.

FIG. 1D is a schematic view of a Lauge-Hansen fracture, to which the teachings of the present disclosure may be applied.

FIG. 2A includes images of a 3D printed anatomic simulacra configured to simulate a multifragmentary fracture according to the teachings of the present disclosure.

FIG. 2B includes images of a 3D printed anatomic simulacra configured to simulate a partial articular fracture according to the teachings of the present disclosure.

FIG. 2C includes images of a 3D printed anatomic simulacra configured to simulate a fragmentary fracture according to the teachings of the present disclosure.

FIG. 2D includes images of a 3D printed anatomic simulacra configured to simulate a complete articular fracture according to the teachings of the present disclosure.

FIG. 3 is a cross-sectional view of a 3D printed anatomic simulacra according to the teachings of the present disclosure.

FIG. 4A is a perspective view of a matrix and support structures of a 3D printed anatomic simulacra constructed in accordance with the teachings of the present disclosure.

FIG. 4B is a side view of a portion of a 3D printed anatomic simulacra, illustrating a cancellous and marrow and constructed in accordance with the teachings of the present disclosure.

FIG. 4C is a side view of a portion of a 3D printed anatomic simulacra, illustrating cortical bone and constructed in accordance with the teachings of the present disclosure.

FIG. 4D is a side view of a portion of a 3D printed anatomic simulacra, illustrating fragmented exterior shell pieces and constructed in accordance with the teachings of the present disclosure.

FIG. 5 is an enlarged perspective view of the matrix and support structures of FIG. 4A.

FIG. 6 is a perspective view of a 3D printed anatomic simulacra configured to represent radius and ulna bones having connective tissue therebetween and constructed in accordance with the teachings of the present disclosure.

FIG. 7A includes progressive images of a simulated Anterior Talofibular Ligament (AFTL) tear using a 3D printed anatomic simulacra according to the teachings of the present disclosure.

FIG. 7B includes progressive images of an interosseous membrane tear after the AFTL tear of FIG. 7A.

FIG. 7C includes progressive images of a distal fibula fracture after the interosseous membrane tear of FIG. 7B.

FIG. 7D includes progressive images of a posterior distal tibia fracture after the distal fibula fracture of FIG. 7C.

FIG. 7E includes progressive images of a medial malleolus fracture after the posterior distal tibia fracture of FIG. 7D.

FIG. 8A is front view of a 3D printed anatomic simulacra constructed according to the teachings of the present disclosure prior to a repair procedure.

FIG. 8B is a front view of a 3D printed anatomic simulacra constructed according to the teachings of the present disclosure after a repair procedure.

FIG. 9A is a front view of an anatomic simulacra comprising a plurality of fibral elements embedded within a matrix and constructed in accordance with the teachings of the present disclosure.

FIG. 9B is a perspective view of a prototype mold used to form the anatomic simulacra of FIG. 9A.

The drawings described herein are for illustration purposes and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. In addition, there is no intention to be bound by any expressed or implied theory presented in the preceding introduction, brief summary or the following detailed description.

The materials and synthetic components disclosed herein may be utilized to establish physical anatomical models of organic anatomy. The components may be 3D printed, or in other words, constructed using additive manufacturing techniques/systems. Further, the anatomy may be human or zootomy, among others. More specifically, the teachings of the present disclosure provide 3D printed anatomic simulacra that are configured to simulate various bone fractures, connective tissue tears, and pretensioned connective tissue in order to simulate various medical procedures, such as by way of example: achilles repair; plantar fasciotomy; wrist fracture repair; rotator cuff repair, and ligament repair, among others. Therefore, the 3D printed anatomic simulacra may be used by surgeons to practice operative procedures and gain knowledge/experience prior to actual procedures on patients.

As set forth herein, 3D printing systems and materials are implemented according to the teachings of the present disclosure to create anatomically synthetic specimens, which are used in the place of conventional cadaveric specimens. Because materials and features/geometries selected for the 3D printing system can be individually tailored to the anatomy of a specific patient, the anatomically synthetic specimens are highly advantageous over conventional cadaveric specimens. For example, the anatomically synthetic specimens are more accurate/representative of the patient undergoing a specific procedure, compared with a conventional cadaveric specimen that is most likely the anatomy of an individual of a different age, and which is continually degrading due to the organic nature of the specimen. Further, specific requirements and equipment for storage and disposal of conventional cadaveric specimens is eliminated with the use of anatomically synthetic specimens. Physicians and staff are also able to practice procedures multiple times and more readily with anatomically synthetic specimens. These and other benefits of the present disclosure will become more apparent from the following detailed description and figures.

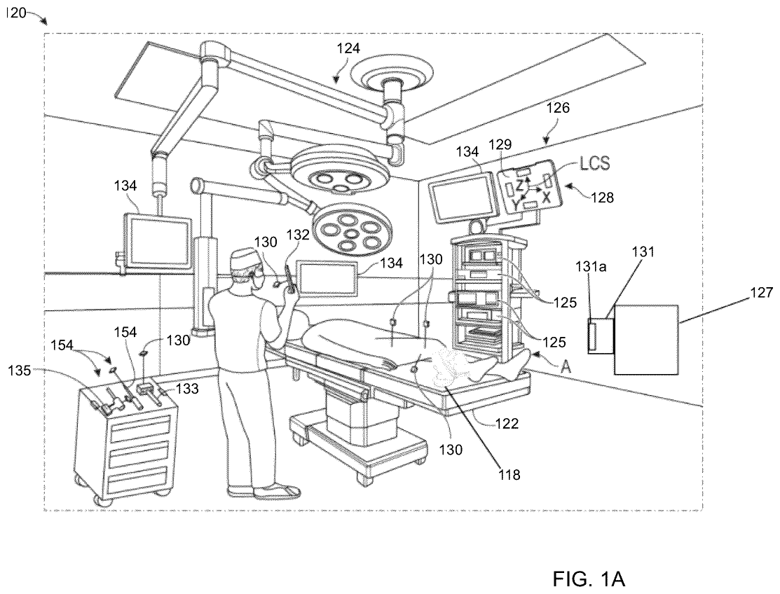

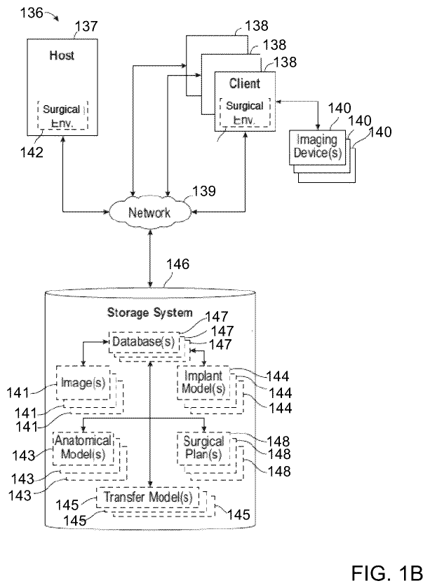

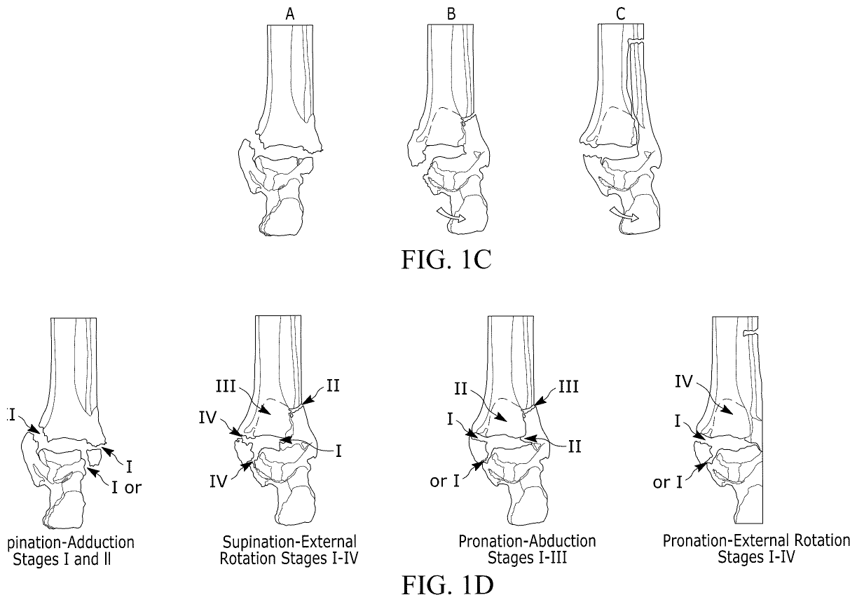

FIG. 1A may provide a surgical suite (e.g., system or assembly) 120 according to an implementation. The surgical suite 120 may be utilized to perform various surgical procedures (e.g., manual surgical procedures, robotic-assisted surgical procedures, surgical training procedures), including but not limited to, an orthopedic procedure such as an arthroscopy or an arthroplasty to restore functionality to one or more bones and/or joints. The surgical procedure may include repair of one or more characteristics associated with a patient. For example, the surgical procedure may include repair of one or more bone pathologies (e.g., defects) associated with a bone of a patient. The surgical procedure may include repair of one or more soft tissues such as a damaged muscle, ligament, tendon or the like. The suite 120 may be utilized in the repair of various locations of the anatomy and other surgical procedures including repair of joints such as the shoulder, foot, ankle, wrist, hand, hip, knee, and spine. The suite 120 may also be used in a surgical training procedure to repair an anatomic simulacra 118. The anatomic simulacra 118 may comprise a 3D printed anatomic simulacra 20a, 20b, 20c, 20d, a 3D printed anatomic simulacra 30, a 3D printed anatomic simulacra 60, a 3D printed anatomic simulacra 80 or an anatomic simulacra 100 described below.

The suite 120 may include an operating table 122 for supporting an anatomy A of a patient and/or the anatomic simulacra 118 as will be described below. The suite 120 may include a light assembly 124, which may include one or more light sources for communicating light towards the patient anatomy A and/or the anatomic simulacra 118.

The suite 120 may include one or more computing devices 125. The computing device(s) 125 may include (e.g., processing) circuitry, including one or more processors coupled to memory, input devices, and/or output devices. The processor(s) may be collectively operable to perform any of the functionality disclosed herein. The computing device(s) 125 may be operable to establish a surgical plan and/or implement the surgical plan for treating the patient. The computing device(s) 125 may be operable to establish a surgical training procedure involving the anatomic simulacra 118.

The suite 120 may include an equipment tower 126. The equipment tower 126 may include one or more modules (e.g., systems), which may incorporate the computing device(s) 125. The module(s) may include a guidance (e.g., navigation or tracking) module 128. The guidance module 128 may include a localizer 129, which may be operatively coupled to the computing device(s) 125. The localizer 129 may include a sensor unit having one or more sensors. One or more trackers 130 may be situated (e.g., fixed or secured) relative to the patient anatomy A and/or the anatomic simulacra 118. The trackers 130 may comprise an anatomy tracker. The trackers 130 may include one or more objects (e.g., markers). The trackers 130 may include active devices (e.g., sensors or light emitting diodes) and/or passive devices (e.g., reflectors). The tracker(s) 130 may be placed relative to the anatomy A, the anatomic simulacra 118 and/or one or more surgical devices (e.g., instruments) 132. The devices 132 may include any of the devices disclosed herein. The devices 132 may include one or more surgical guides 133, cutting instruments 135, and/or surgical probes 154. The tracker(s) 130 may be placed relative to one or more landmarks of the anatomy A and/or the anatomic simulacra 118. The surgeon or clinical user may manipulate the surgical devices 132 during a surgical procedure. The localizer 129 may be operable to determine (e.g., track) the position and/or orientation of the trackers 130. The guidance module 128 may be operable to determine the position and/or orientation of each tracker 130 with respect to a (e.g., localizer or global) coordinate system (e.g., framework) LCS of the localizer 129. The suite 120 may be operable to transfer coordinates in the coordinate system LCS to another coordinate system (e.g., framework), such as a local coordinate system of a surgical device 132 or a coordinate system associated with a surgical planning system, and/or vice versa, using various transformation techniques.

The suite 120 may include one or more displays 134. The computing device(s) 125 may be operable to cause the display(s) 134 to display various data and/or information associated with a patient, including a surgical plan and/or guidance information. A surgeon or clinical user may interact with the display(s) 134. The guidance module 128 may be operable to cause the display(s) 134 to display a position and/or orientation of the tracker(s) 130 and/or associated surgical device(s) 132 relative to the anatomy A of the patient and/or the anatomic simulacra 118.

The suite 120 may include a robot 127, which may be in communication with the computing devices 125. The computing devices 125 may be operable to control the robot 127. In some examples, the computing devices 125 may cause the robot 127 to perform a portion or all of a surgical procedure or surgical training procedure. In some examples, the computing devices 125 may be used to control the robot 127 to evaluate one or more characteristics of the patient and/or target anatomy. In other examples, the computing devices 125 may be operable to validate a movement of the robot 127 relative to the anatomic simulacra 118.

The robot 127 may be used to assist with and/or perform a surgical procedure, a training procedure, or both. In some examples, the robot 127 may be a hand-held robot. In some other examples, the robot 127 may include a robotic arm 131. The robot 127 may include a base and an end effector 131a operatively coupled with the base. The robot 127 may include one or more actuators to move the end effector 131a, the base, or both. The end effector 131a may comprise a working end of the robot 127, and may include a proximal portion to be operatively coupled to the base, and a distal portion that includes a surgical instrument or tool. The distal portion of the end effector 131a may include, but is not limited to, a burr, a drill, a probe, a saw, a medical device, a measuring device, one or more sensors, a microscope, a camera, a light, an endoscope, an ultrasound probe, an irrigation device, a suction device, a radiotherapy device, and/or any other instrument or tool useful for surgery, surgical planning, and/or surgical navigation. In one example, the anatomic simulacra 118 may be used to validate or verify an accuracy of a movement of the robotic arm 131 prior to the performance of the surgical procedure. The robot 127 may include a display.

FIG. 1B may provide a surgical (e.g., planning or guidance) system (e.g., assembly) 36 according to an implementation. The surgical suite 120 may incorporate and/or may interface with the surgical system 136. The surgical system 136 may be utilized for planning and/or executing orthopedic and/or other surgical procedures, including pre-operatively, intra-operatively and/or post-operatively to create, edit, execute and/or review surgical plans. The surgical system 136 may be utilized for various orthopedic and other surgical procedures, including any of the procedures disclosed herein. The surgical system 136 may be utilized in the design and/or placement of various surgical constructs (e.g., devices). Surgical constructs may include any item assembled and/or placed in the patient anatomy A and/or the anatomic simulacra 118 during surgery to repair, place and/or support tissue. Surgical constructs may include grafts and implants such as an implant incorporated into a prosthesis and/or surgical instruments such as a transfer guide for positioning one or more surgical instruments, implants and/or grafts. The grafts may include synthetic and/or biological materials, such as an allograft or autograft. The systems and methods disclosed herein may be utilized in the repair of various locations of the anatomy and various surgical procedures including repair of bones and joints associated with the anatomy A and/or the anatomic simulacra 118 such as the shoulder, foot, ankle, wrist, hand, hip, knee and spine. The surgical system 136 may be utilized to perform other orthopedic procedures, including sports medicine procedures which may be performed to repair and/or reconstruct ligament(s) and/or tendon(s) and which may include use of graft(s). Sports medicine procedures may include a rotator cuff repair and anterior cruciate ligament (ACL) and/or posterior cruciate ligament (PCL) repairs.

The surgical system 136 may include a host computer 137 and one or more client computers 138. The host computer 137 may be configured to execute one or more software programs. In implementations, the host computer 137 may be more than one computer jointly configured to process software instructions serially and/or in parallel. The computing device(s) 125 of the surgical suite 120 (FIG. 1A) may include and/or may interface with the computer(s) 137, 138. Further, the robot 127 may interface with the computers 137, 138.

The computers 137, 138 may be operable to communicate with one or more networks such as a network 139 comprised of one or more computing devices. The network 139 may be a private local area network (LAN), a private wide area network (WAN), the Internet, or a mesh network.

The host computer 137 and each client computer 138 may include one or more computer processors, memory, storage means, network devices, and input and/or output devices and/or interfaces. The input devices may include keyboards, mice and touch screens. The output devices may include monitors, speakers and printers. The memory may include UVPROM, EEPROM, FLASH, RAM, ROM, DVD, CD, a hard drive, or other computer readable medium which may store data and/or other information relating to the planning and implementation techniques disclosed herein. The computer processor(s) may be operable to individually and/or collectively execute any of the functionality disclosed herein.

The host computer 137 and each client computer 138 may be a desktop computer, laptop computer, smart phone, tablet, wearable (e.g., augmented reality) device, or any other computing device. The interface may be adapted to facilitate communication with the other systems and/or components of the network 139, which may include the various modules of the surgical suite 120 (FIG. 1A).

Each client computer 138 may be operable to communicate with the host computer 137 directly via a direct client interface or over the network 139. In another implementation, the client computers 138 may be operable to communicate with each other directly via a peer-to-peer interface.

The surgical system 136 may include, or may interface with, one or more imaging devices 140. The host computer 137 and/or client computer(s) 138 may be coupled to the imaging device(s) 140. Each imaging device 140 may be configured to capture or acquire imagery, including one or more images 141 of patient anatomy A and/or the anatomic simulacra 118 that may reside within a scan field (e.g., window) of the imaging device 140. The imagery may include two-dimensional (2D) and/or three-dimensional (3D) greyscale and/or color images 141. Various imaging devices 140 may be utilized, such as an X-ray machine, CT machine or MRI machine that may be operable to obtain one or more images of the anatomy A of the patient and/or the anatomic simulacra 118.

The client computers 138 may be operable to execute one or more software programs, including programs for controlling various surgical tools, which may include the robot 127. Each client computer 138 may be operable to access and locally and/or remotely execute a surgical (e.g., planning or guidance) environment 142. The surgical environment 142 may be a standalone software package or may be incorporated into another surgical tool. The surgical environment 142 may be configured to communicate with the host computer 137 either over the network 139 or directly through the direct client interface. In implementations, the host computer 137 may be operable to execute the surgical environment 142.

The surgical environment 142 may be operable to obtain (e.g., acquire) imagery of patient anatomy A and/or the anatomic simulacra 118, including one or more images 141. The surgical environment 142 may be operable to interact with one or more of the imaging devices 140 to capture, acquire or otherwise obtain image(s) 141 of patient anatomy A and/or the anatomic simulacra 118. The surgical environment 142 may be operable to provide a display (e.g., visualization) of one or more images 141, virtual anatomical (e.g., bone) models 143, and/or surgical device models including virtual surgical construct (e.g., implant or graft) models 144 and/or virtual surgical transfer (e.g., instrument or guide) models 145 via one or more graphical user interfaces (GUI). The anatomical model 143 may be representative of one or more bones and/or soft tissue, which may be associated with a respective joint. Each image 141, anatomical model 143, implant model 144, transfer model 145 and/or other data and information may be stored in one or more files or records according to a specified data structure. The implant model 144 may include one or more components. The implant model 144 may be associated with various implants, such as bases (e.g., base plates or trays) configured to be coupled to a respective articulation member, and bone plates configured to interconnect adjacent bones or bone fragments. The articulation member may have an articular surface dimensioned to mate with an articular surface of an opposed bone or implant. As described below, the client computers 138 may execute one or more software programs defined by the surgical environment 142.

The surgical system 136 may include at least one storage system 146, which may be operable to store or otherwise provide data to other computing devices. The storage system 146 may be a storage area network device (SAN) configured to communicate with the host computer 137 and/or the client computers 138 over the network 139. In implementations, the storage system 146 may be incorporated within, or may be directly coupled to, the host computer 137 and/or client computers 138. The storage system 146 may be configured to store various information, such as one or more computer software instructions, data, database files and configurations. In implementations, the storage system 146 may be remote (e.g., server or cloud-based storage) from the host computer 137 and/or client computers 138. The storage system 146 may be connected with the host computer 137 and/or client computers 138 through a network connection which may be wired or wireless.

In implementations, the surgical system 136 may be a client-server architecture configured to execute computer software on the host computer 137, which may be accessible by the client computers 138 using either a thin client application or a web browser executing on the client computers 138. The host computer 137 may be operable to load the computer software instructions from local storage, or from the storage system 146, into memory and may execute the computer software using the one or more computer processors. Other architectures may be utilized, including cloud computing.

The surgical system 136 may include one or more databases 147. The databases 147 may be stored at a central location, such as the storage system 146. In other implementations, one or more databases 147 may be stored at the host computer 137 and/or may be a distributed database provided by one or more of the client computers 138. Each database 147 may be a relational database configured to associate one or more images 141, anatomical models 143, implant models 144 and/or transfer models 145 to each other and/or a respective surgical plan(s) 148. Each surgical plan 148 may be associated with the anatomy of a respective patient and/or the anatomic simulacra 118. Each image 141, anatomical model 143, implant model 144, transfer model 145 and/or surgical plan 148 may be assigned a unique identifier or database entry. The database 147 may be configured to store data and other information corresponding to the images 141, anatomical models 143, implant models 144, transfer models 145 and/or surgical plans 148 in one or more database records or entries, and/or may be configured to link or otherwise associate one or more files corresponding to each respective image 141, anatomical model 143, implant model 144, transfer model 145 and/or surgical plan 148. Images 141, anatomical models 143, implant models 144, transfer models 145 and/or associated surgical plans 148 stored in the database(s) 147 may correspond to respective patient anatomies and/or the anatomic simulacra 118 from prior, planned and/or hypothetical surgical cases, and may be arranged into one or more predefined categories such as sex, age, race, ethnicity, defect category, procedure type, surgeon, and/or facility or organization.

Each image 141 and/or anatomical model 143 may include data and other information obtained from one or more medical devices or tools, such as the imaging devices 140. The anatomical model 143 may include coordinate information relating to an anatomy of the patient and/or the anatomic simulacra 118 obtained or derived from image(s) 141 captured or otherwise obtained by the imaging device(s) 140. Each implant model 144 and transfer model 145 may include geometry and/or coordinate information associated with a predefined design or a design established or modified by the surgical environment 142. The surgical environment 142 may incorporate and/or interface with one or more modeling packages, such as a computer aided design (CAD) package, to render the models 143, 144, 145 as 2D and/or 3D volumes or constructs, which may overlay one or more of the images 141 in a display window (e.g., screen) of a GUI.

The anatomical (e.g., bone or joint) model(s) 143 and/or implant model(s) 144 may be associated with a local coordinate (e.g., reference) system and/or a global (e.g., common) coordinate (e.g., reference) system. The surgical environment 142 may define the global coordinate system utilizing any of suitable technique. The global coordinate system may be associated with a set of coordinate values. The global coordinate system may include the localizer coordinate system LCS (FIG. 1A). In implementations, the global coordinate system may be representative of an anatomical position of the patient and/or the anatomic simulacra 118, which may be the same or may differ from an acquisition position associated with the image data which may be acquired by the imaging device(s) 140. The global coordinate system may be established with respect to Z (0, 0, 1), Y (0, 1, 0) and X (1, 0, 0) axes. The Z axis of the global coordinate system may correspond to a vertical direction. The X and Y axes of the global coordinate system may extend in respective horizontal directions along a horizontal plane. The global coordinate system may be established relative to one or more anatomical planes of the anatomy A and/or the anatomic simulacra 118. An orientation of the anatomical model(s) 143 relative to the global coordinate system may be representative of an anatomical (e.g., upright or vertical) position of the patient, or an anatomical position of the anatomic simulacra 118. The axes of the local and/or global coordinate systems may be established with respect to an acquisition orientation of the imagery associated with the imaging device(s) 140. The surgical environment 142 may be operable to register the anatomical model(s) 143 associated with the anatomy of a patient and/or the anatomic simulacra 118 from the respective local coordinate system to the global coordinate system. The surgical environment 142 may be operable to evaluate and/or display the anatomical model(s) 143 with respect to the local and/or global coordinate system, including establishing a surgical plan 148 and/or performing a range of motion simulation, which may be associated with one or more implant model(s) 144 placed relative to the anatomical model(s) 143.

The implant models 144 may correspond to (e.g., physical) implants and components of various configurations, shapes, sizes, procedures and/or instrumentation. The implant model 144 may be associated with a patient-specific implant for treating a single patient or particular patient associated with the anatomic simulacra 118, or may be non-patient specific (e.g., generic) for treating different patients or generic ones of the anatomic simulacra 118. Each implant may include, or may otherwise be associated with, one or more components that may be situated at a surgical site including grafts and various fixation devices such as screws, anchors, nails and suture. Each implant model 144 may correspond to a single (e.g., monolithic) component or may include two or more components that may be configured to establish an assembly. The implant model 144 may include a base (e.g., base plate or tray) coupled to an articulation member, bone plates configured to interconnect adjacent bones or bone fragments, intermedullary nails and/or suture anchors. The articulation member may have an articular surface dimensioned to mate with an articular surface of an opposed bone or implant. The implant(s), instrument(s) and/or associated component(s) may be formed of various materials, including metallic and/or non-metallic materials. Each anatomical model 143, implant model 144 and transfer model 145 may correspond to 2D and/or 3D geometry and may be utilized to generate a wireframe, mesh and/or solid construct in a display.

The transfer model(s) 145 may be associated with respective transfer devices. The transfer devices may include configurable (e.g., reusable), patient-specific and/or procedure specific devices. The transfer devices may include guides, which may be adapted to guide one or more surgical devices, including guide elements (e.g., K-wires and pins) and/or cutting instruments 135.

Each surgical plan 148 may be associated with one or more of the images 141, anatomical models 143, implant models 144 and/or transfer models 145. The surgical plan 48 may include various parameters associated with the respective images 141, anatomical models 143, implant models 144 and/or transfer models 145. The parameters may relate to bone characteristics (e.g., bone density and/or bone quality) associated with patient anatomy A and/or the anatomic simulacra 118 captured in the image(s) 141. The surgical plan 148 may include parameters including spatial information relating to relative placement and coordinate information of the selected anatomical model(s) 143, implant model(s) 144 and/or transfer model(s) 145.

The surgical plan 148 may include one or more revisions to an anatomical (e.g., bone, joint, the and/or the anatomic simulacra 118) model 143 and/or information relating to placement of an implant model 144 and/or transfer model 145 relative to the original and/or revised anatomical model 143. The surgical plan 148 may include coordinate information relating to the revised anatomical model 143 and a relative placement of the implant model 144 and/or transfer model 145 in predefined data structure(s). The surgical environment 142 may be operable to make one or more revisions to a transfer model 145 automatically or in response to user interaction with the user interface. Revisions to the anatomical model 143, implant model 144, transfer model 145 and/or surgical plan 148 may be stored in the database 147 automatically and/or in response to user interaction with the system 136.

One or more surgeons and other clinical users may be provided with a surgical environment 142 via the client computers 138 and may simultaneously access the image(s) 141, anatomical model(s) 143, implant model(s) 144, transfer model(s) 145 and/or surgical plan(s) 148 stored in the database(s) 147. Each user may interact with the surgical environment 142 to create, view, edit (e.g., modify) and/or approve various aspects of the surgical plan 148. Each client computer 138 may be configured to store local instances of the images 141, anatomical models 143, implant models 144, transfer models 145 and/or surgical plans 148, which may be synchronized in real-time or periodically with the database(s) 147. The surgical environment 142 may be a standalone software package executed on a client computer 138 or may be provided as one or more services executed on the host computer 137.

Advantageously, the various 3D printed anatomic simulacra illustrated and described herein are manufactured using a 3D printing process, which may include vat photopolymerization (VPP), in which ultraviolet (UV) light is used to cure liquid photopolymer resins. More specifically, the UV light cures the photopolymer resin layer by layer, and a platform moves down as more layers are built on top of one another. It should be understood, however, that other 3D printing processes, or additive manufacturing (AM) techniques, may be employed while remaining within the scope of the present disclosure. Thus, the specific use of VPP herein should not be construed as limiting the scope of the present disclosure.

By way of example, and referring to FIGS. 1C and 1D, exemplary classifications of ankle fractures are illustrated, namely, the Danis-Weber classifications (FIG. 1C) and the Lauge-Hansen classifications (FIG. 1D). In Danis-Weber, the classifications include: Type A: fracture of the lateral malleolus distal to the syndesmosis (the connection between the distal ends of the tibia and fibula); Type B: fracture at the level of the tibial plafond (syndesmosis). Fracture of the fibula at the level of the syndesmosis; Type C: fracture proximal to the level of the tibial plafond and often have an associated syndesmotic injury. In Lauge-Hansen, supination-adduction occurs at stages I and II, supination-external rotation at stages I-IV, pronation-abduction at stages I-III, and pronation-external rotation at stages I-IV. These classifications of ankle fractures and soft tissue tears, among other types of bone fractures and soft tissue tears, may be simulated by the 3D printed anatomic simulacra as described in greater detail below.

### Sequential Fracture

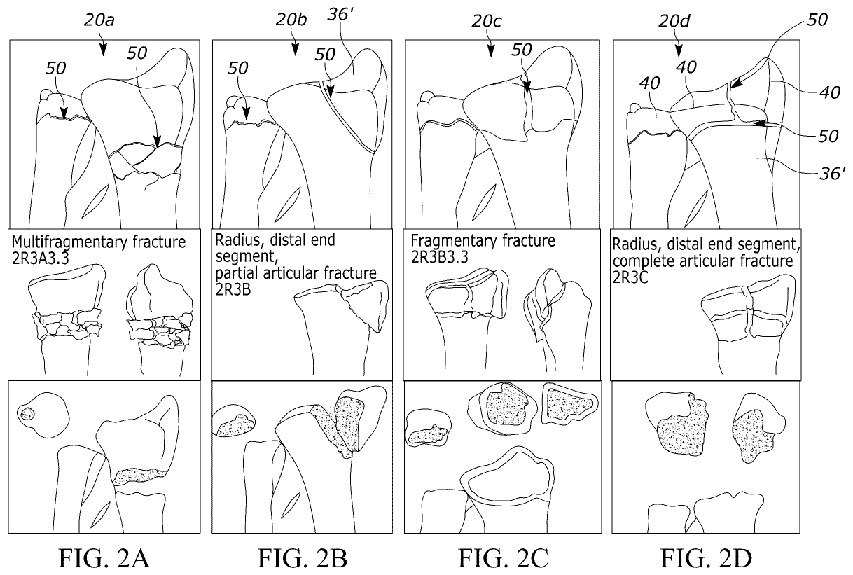

Referring to FIGS. 2A-2D , different types of fractures may be simulated using 3D printed anatomic simulacra 20a, 20b, 20c, 20d constructed according to the teachings herein. In these examples, various types of wrist fractures are illustrated, however, it should be understood that any type of bone fracture (e.g., ankle, knee, among others) may be simulated using the 3D printed anatomic simulacra of the present disclosure. As shown, the 3D printed anatomic simulacra may be configured to simulate a multifragmentary fracture (FIG. 2A), a partial articular fracture (FIG. 2B), a fragmentary fracture (FIG. 2C), or a complete articular fracture (FIG. 2D).

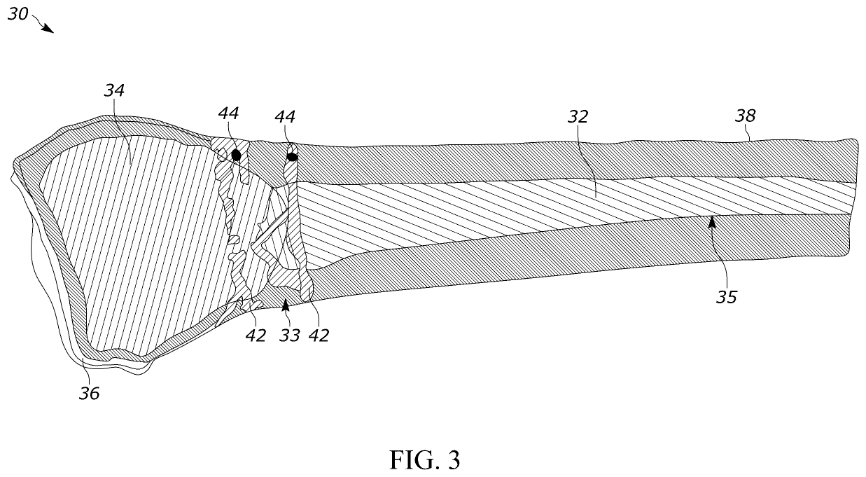

Referring specifically to FIGS. 3, 4A-4D, and 5, a 3D printed anatomic simulacra is illustrated and generally indicated by reference numeral 30, which in this form is a radius bone of a forearm, intended to be used to simulate a wrist fracture for repair. As set forth above, the 3D printed anatomic simulacra 30 may be manufactured using a VPP 3D printing process. As shown, the 3D printed anatomic simulacra 30 includes: an optional core 32, which may be configured to simulate marrow; an inner structure 34, which may be configured to simulate cancellous, disposed proximate an upper portion 33 of the core 32; an upper exterior shell 36, which may be configured to simulate cortical bone, surrounding the inner structure 34 and the upper portion 33 of the core 32; a lower exterior shell 38, which may also be configured to simulate cortical bone, surrounding a lower portion 35 of the core 32; a plurality of fragmented exterior shell pieces 40, which may be configured to represent cortical bone (and more specifically, fractured cortical bone), extending between the upper exterior shell 36 and the lower exterior shell 38; a removable matrix 42 extending between the inner structure 34 and the core 32; and a plurality of support structures 44 embedded within the removable matrix 42 and extending throughout the inner structure 34. As set forth in greater detail below, the removable matrix 42 may be configured to be removed from the 3D printed anatomic simulacra 30 before a simulated medical procedure, thereby resulting in a simulated fracture, which in this form is a multifragmentary fracture (also shown in FIG. 2A).

The core 32, which is configured to simulate marrow in this form of a 3D printed anatomic simulacra, may be a porous material. More specifically, the material of the core 32 is a blended gelatinous material with a fill pattern, or print density that is relatively low and a semi-solid structure.

The inner structure 34, which is configured to simulate cancellous, may be one of a subchondral cancellous, an epiphysis cancellous, or a metaphysis cancellous. Thus, the inner structure 34 may be a porous material. More specifically, the material of the inner structure 34 is a blended composite material with a fill pattern, or print density comprising a network structure comprising intersecting paths with suspended volumes, wherein the individual structures of the network may vary. It should be understood that the inner structure 34 may be the innermost component of the 3D printed anatomic simulacra 30 (i.e., no core 32) while remaining within the scope of the present disclosure.

The upper exterior shell 36, the lower exterior shell 38, and the fragmented exterior shell pieces 40, which may be configured to simulate cortical bone, are generally printed with a polymer material. More specifically, the material of the upper exterior shell 36, the lower exterior shell 38, and the fragmented exterior shell pieces 40 may have a higher density than the core 32 and/or the inner structure 34 with a fill pattern, or print density having varying structures.

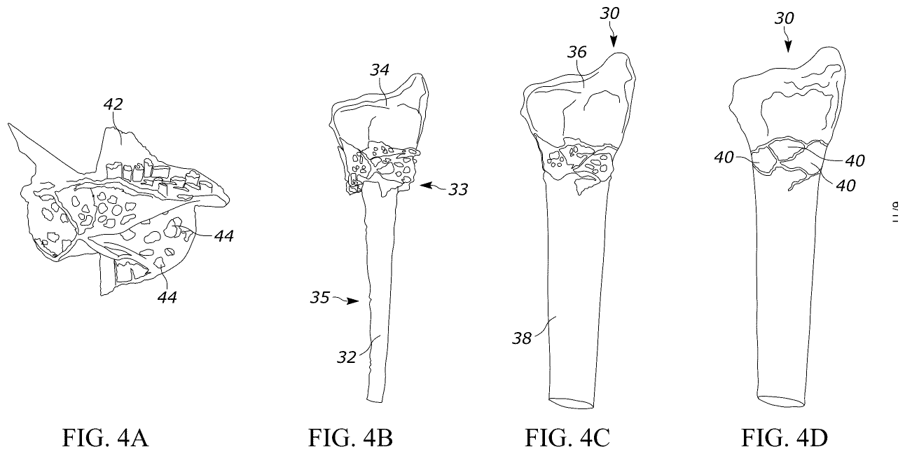

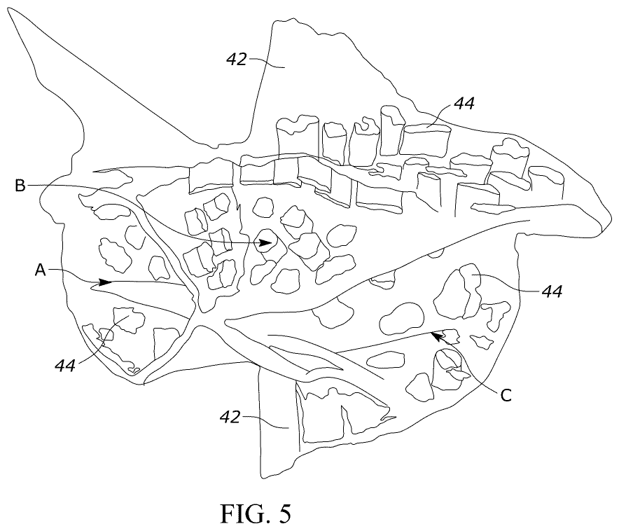

The support structures 44 are embedded within the removable matrix 42, which are more clearly shown in FIG. 5. Generally, the support structures 44 comprise a material having a modulus of elasticity higher than a modulus of elasticity of the inner structure 34 and a modulus of elasticity of the core 32. With the higher modulus of elasticity of the support structures 44, and the absence of the removable matrix 42, when the 3D printed anatomic simulacra 30 is displaced during use, portions of the 3D printed anatomic simulacra 30 sequentially fracture, which is described in greater detail below. The sequential fractures are preconfigured with the geometry, location, and orientation of the support structures 44, along with the geometries and locations of the fragmented exterior shell pieces 40. More specifically, with the absence of the removable matrix 42, preconfigured fracture locations 50 (i.e., peripheral gaps between the fragmented exterior shell pieces 40 and/or adjacent upper exterior shell 36 and/or lower exterior shell 38) are created in the 3D printed anatomic simulacra 20a-20d (FIGS. 2A-2D ; the preconfigured fracture locations 50 remain filled with the removable matrix 42 in FIG. 4D).

Referring specifically to FIG. 5, the support structures 44 may be disposed in zones (e.g., A, B, C) throughout the removable matrix 42, wherein the borders of the zones correspond with the preconfigured fracture locations 50. Accordingly, the support structures 44 may extend at different angles within each of the zones, and the support structures 44 may define different cross-sectional areas and lengths as shown. the material of the support structures 44 may be a solid or flexible material with a uniform pattern, or print density.

As set forth above, the removable matrix 42 defines the preconfigured fracture locations 50 (after the removable matrix 42 is removed). After the 3D printed anatomic simulacra 30 is formed, the removable matrix 42 is removed with a solution. The removable matrix 42 is a low density polymer that is capable of being dissolved by a solution, such as polyethylene glycol (PEG) by way of example. The solution may be water.

Referring back to FIGS. 2A-2D , the sequential fracture of the various 3D printed anatomic simulacra 20a-20d is now described in greater detail. As set forth above, with the absence of the removable matrix 42 and the lower modulus of elasticity of the support structures 44, when the 3D printed anatomic simulacra 20a-20d are displaced during use, portions thereof sequentially fracture. With specific reference to FIG. 2A, each of the preconfigured fracture locations 50 are configured to simulate a multifragmentary fracture. Referring to FIG. 2B, each of the preconfigured fracture locations 50 are configured to simulate a partial articular fracture of the 3D printed anatomic simulacra 20b. In FIG. 2C, each of the preconfigured fracture locations 50 are configured to simulate a fragmentary fracture of the 3D printed anatomic simulacra 20 c. And further, in FIG. 2D, each of the preconfigured fracture locations 50 are configured to simulate a complete articular fracture of the 3D printed anatomic simulacra 20d. Throughout these examples, the fragmented exterior shell piece 40 is positioned adjacent to an exterior shell 36′, as opposed to being located between two distinct exterior shell pieces as previously illustrated and described.

It should be understood that the fragmented exterior shell pieces 40 may be located in a variety of positions along a cortical bone and are thus not limited to the specific illustrations herein. For example, referring to FIGS. 2A-2D , the fragmented exterior shell pieces 40 may be located adjacent to an exterior shell 36′, rather than disposed between upper and lower exterior shells 36/38 (e.g., FIG. 4D). Further, only one fragmented exterior shell piece 40 may be implemented while remaining within the scope of the present disclosure.

### Sequential Tear

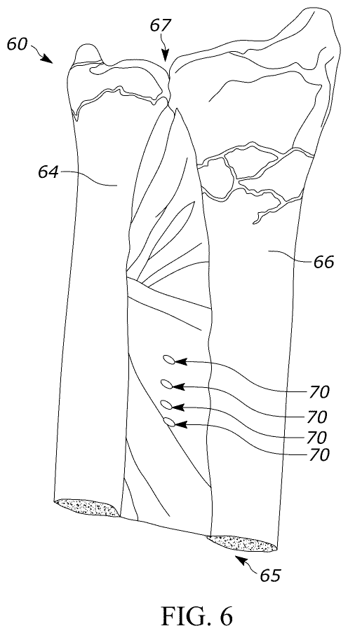

Referring now to FIG. 6, another form of a 3D printed anatomic simulacra is illustrated and generally indicated by reference numeral 60. This 3D printed anatomic simulacra 60 may include a flexible connective tissue 62 connecting at least two components 64/66. The components 64/66 shown may be the 3D printed anatomic simulacra 30 illustrated and described above, namely, anatomical bones having the preconfigured fracture locations 50 and related construction. Thus, in one form, the at least two components 64/66 are configured to simulate anatomical bones. However, the components 64/66 are not limited to such anatomical bones and may be any of a variety of anatomical components, such as by way of example muscles or monolithic bones (not shown).

As shown, the flexible connective tissue 62 defines a plurality of voids 70 extending from a proximal end portion 65 to a distal end portion 67 of the at least two components 64/66. The voids 70 are configured to sequentially tear under an applied load, thereby simulating a predefined tear classification, which is described in greater detail below. Generally, the flexible connective tissue comprises a printed elastomeric material.

In one variation, the flexible connective tissue 62 may be configured to simulate ligaments. In another variation, the at least two components 64/66 may be configured to simulate an anatomical bone and muscle, respectively, and the flexible connective tissue 62 is configured to simulate tendons.

As shown, the voids 70 may define perforations, which are openings that extend all the way through the flexible connective tissue 62. In other forms, the voids 70 may define areas of reduced cross-sectional area of the flexible connective tissue 62, or combinations of openings and reduced cross-sectional areas. The voids 70 function to allow for sequential tearing, or separation of the flexible connective tissue 62, thereby simulating tear classifications.

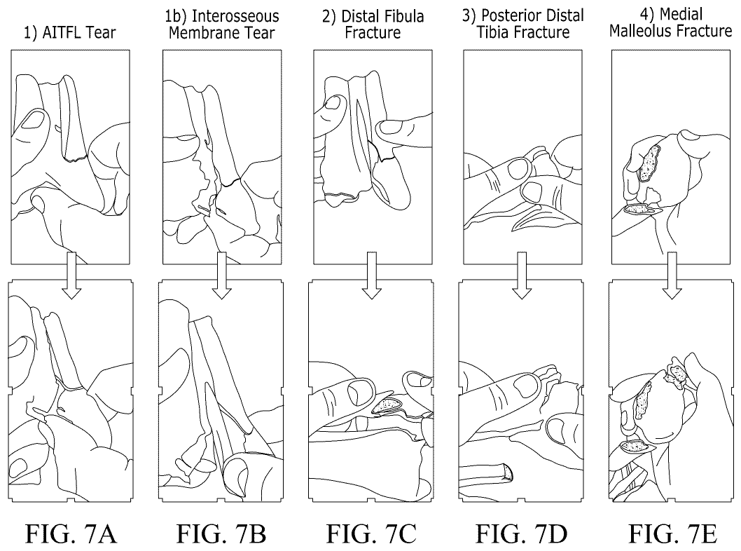

More specifically, and with reference to FIGS. 7A-7E , both the 3D printed anatomic simulacra 30 having the sequential fracture with fragmented exterior shell pieces 40 (and related structure), and the 3D printed anatomic simulacra 60 having the sequential tear with flexible connective tissue 62 are illustrated together in an exemplary and nonlimiting form of the present disclosure. First, an anterior talofibular ligament (ATFL) tear is shown in FIG. 7A, the flexible connective tissue 62 (via the voids 70) is configured to sequentially tear under an applied load. Next, as shown in FIG. 7B, an interosseous membrane tear is sequentially effected with the applied load, again through the use of the voids 70 in the flexible connective tissue 62. Moving to FIG. 7C, a distal fibula fracture is then sequentially effected with the applied load, which occurs as a result of the fragmented exterior shell pieces 40, or preconfigured fracture locations 50, and the related structure, i.e., the support structures 44 (not shown) having a higher modulus of elasticity. Next, another sequential fracture is shown in FIG. 7D, which is a posterior distal tibia fracture. The posterior distal tibia fracture is similarly effected with the applied load and occurs as a result of the fragmented exterior shell pieces 40, or preconfigured fracture locations 50, and the related structure, i.e., the support structures 44 (not shown) having a higher modulus of elasticity. And in FIG. 7E, yet another sequential fracture is shown with a medial malleolus fracture. The medial malleolus fracture is similarly effected with the applied load and occurs as a result of the fragmented exterior shell pieces 40, or preconfigured fracture locations 50, and the related structure, i.e., the support structures 44 (not shown) having a higher modulus of elasticity.

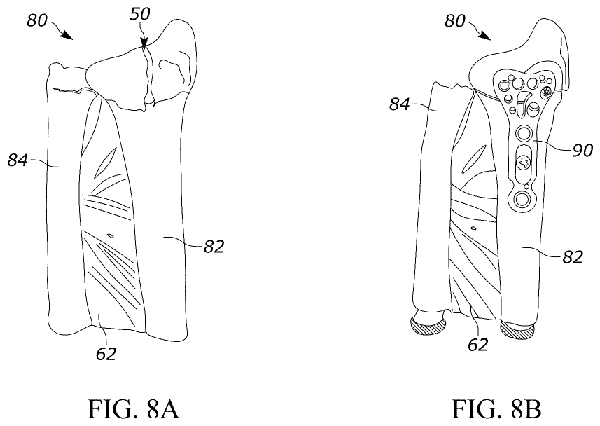

Another example is illustrated in FIGS. 8A and 8B, with the 3D printed anatomic simulacra 80 before a simulated repair/implantation. In FIG. 8A, the 3D printed anatomic simulacra 80 includes a radial bone 82 and an ulna bone 84, wherein the radial bone 82 has a fragmentary fracture (see also FIG. 2C). The fragmentary fracture has been created using the teachings set forth above, namely, preconfigured fracture locations 50, and the related structure, i.e., the support structures 44 (not shown) having a higher modulus of elasticity. The flexible connective tissue 62 is also shown in this example but does not have any tears. Using the repair procedures according to the manufacturer's specifications, a repair plate 90 is installed to repair the fragmentary fracture. Thus, using the various 3D printed anatomic simulacra illustrated and described herein, surgeons and staff may practice a surgical procedure on a number of specimens prior to an actual patient procedure to improve outcomes.

### Pre-Tensioned Cast Fibers

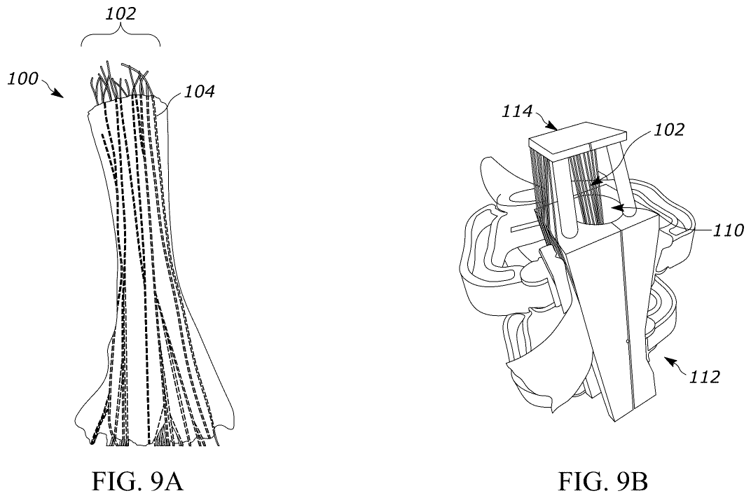

Referring to FIGS. 9A and 9B, another anatomic simulacra is illustrated and generally indicated by reference numeral 100. The anatomic simulacra 100 generally comprises a plurality of fibral elements 102 embedded within a matrix 104. The fibral elements 102 are configured to simulate organic ligaments or tendons and are thus manufactured using a process that pre-tensions the fibral elements 102. With pre-tensioned fibral elements 102, specific procedures can be practiced on the anatomic simulacra 100 such as, by way of example, achilles repair or plantar fasciotomy, among others.

In one form, the anatomic simulacra 100 may be manufactured by a process of placing the fibral elements 102 under tension within a core 110 of a mold 112. The mold 112 is merely exemplary and is shown with two mold halves being clamped together, however, other mold configurations may be implemented while remaining within the scope of the present disclosure. In this form, the fibral elements 102 are tensioned over a platform 114, which extends from an upper portion of the mold 112, and the fibral elements 102 are clamped (not shown) at a lower end portion of the mold 112. The fibral elements 102 may be tensioned to a predefined load, which may be monitored and controlled with a tensiometer (not shown). The fibral elements 102 may be a textile material, which may include a urethane material. Generally, the fibral elements 102 are a material that have an elasticity that matches organic ligaments and/or tendons. In other forms, the fibral elements 102 may be nylon and/or polyester.

The core 110 is filled with a material that forms the matrix 104, which is generally a silicone material. In one variation, the matrix 104 comprises a composite material having a durometer proximate an exterior portion of the anatomic simulacra 100 that is higher than a durometer proximate an interior portion of the anatomic simulacra 100 to facilitate passing of needles during simulated procedures. As such, the mold 112 may have multiple cavities (not shown) to accommodate matrix materials having different durometers.

After the core 110 is filled, the matrix 104 is cured and the fibral elements 102 and matrix 104 are released from the mold. With the fibral elements 102 under tension, displacement of the anatomic simulacra 100 is limited during use, thereby simulating organic patient anatomy.

Geometry and material properties for each of the components of the 3D printed anatomic simulacra, and anatomic simulacra for the pre-tensioned cast fibers, (collectively “anatomic simulacra”) illustrated and described herein may be obtained through imaging data, such as by way of example, MRI (magnetic resonance imaging) or CT (computed tomography) scans, among others. Therefore, the anatomic simulacra may be configured to simulate the anatomy of an actual patient, thus providing more accurate specimens for surgical planning and preparation. As a result, more positive outcomes may be possible in surgical procedures through the use of the innovative anatomic simulacra set forth herein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A 3D printed anatomic simulacra comprising:
a core;
an inner structure disposed proximate an upper portion of the core;
an upper exterior shell surrounding the inner structure and the upper portion of the core;
a lower exterior shell surrounding a lower portion of the core;
at least one fragmented exterior shell piece extending between the upper exterior shell and the lower exterior shell;
a removable matrix extending between the inner structure and the core; and
a plurality of support structures embedded within the removable matrix, the plurality of support structures extending throughout the inner structure,
wherein the removable matrix is configured to be removed from the 3D printed anatomic simulacra before a simulated medical procedure.

2. The 3D printed anatomic simulacra according to claim 1, wherein the core is configured to simulate marrow.

3. The 3D printed anatomic simulacra according to claim 2, wherein the core is a porous material.

4. The 3D printed anatomic simulacra according to claim 1, wherein the inner structure is configured to simulate a cancellous.

5. The 3D printed anatomic simulacra according to claim 4, wherein the cancellous is at least one of a subchondral cancellous, an epiphysis cancellous, or a metaphysis cancellous and the inner structure is a porous material.

6. The 3D printed anatomic simulacra according to claim 1, wherein the upper exterior shell, the lower exterior shell, and the at least one fragmented exterior shell piece are configured to simulate cortical bone.

7. The 3D printed anatomic simulacra according to claim 1, wherein the at least one fragmented exterior shell piece comprises a plurality of fragmented exterior shell pieces configured to simulate a multifragmentary fracture.

8. The 3D printed anatomic simulacra according to claim 1, wherein the at least one fragmented exterior shell piece is configured to simulate a partial articular fracture.

9. The 3D printed anatomic simulacra according to claim 1, wherein the at least one fragmented exterior shell piece comprises a plurality of fragmented exterior shell pieces and the plurality of fragmented exterior shell pieces are configured to simulate a fragmentary fracture or a complete articular fracture.

10. The 3D printed anatomic simulacra according to claim 1, wherein the plurality of support structures comprise a material having a modulus of elasticity higher than a modulus of the inner structure and a modulus of the core.

11. The 3D printed anatomic simulacra according to claim 1, wherein the plurality of support structures are disposed in zones.

12. The 3D printed anatomic simulacra according to claim 1, wherein the plurality of support structures extend at different angles or the plurality of support structures define different cross-sectional areas and lengths.

13. A 3D printed anatomic simulacra comprising:
a flexible connective tissue connecting at least two components, the flexible connective tissue defining a plurality of voids extending from a proximal end portion to a distal end portion of the at least two components,
wherein the plurality of voids are configured to sequentially tear under an applied load, thereby simulating a predefined tear classification.

14. The 3D printed anatomic simulacra according to claim 13, wherein the flexible connective tissue comprises a silicone material.

15. The 3D printed anatomic simulacra according to claim 13, wherein the at least two components are configured to simulate anatomical bones.

16. The 3D printed anatomic simulacra according to claim 13, wherein the flexible connective tissue is configured to simulate ligaments.

17. The 3D printed anatomic simulacra according to claim 13, wherein the plurality of voids define perforations.

18. An anatomic simulacra comprising a plurality of fibral elements embedded within a matrix, the anatomic simulacra manufactured by a process of:
placing the plurality of fibral elements under tension within a core of a mold;
filling the core of the mold with a matrix;
curing the matrix; and
releasing the plurality of fibral elements and the matrix from the mold,
wherein the plurality of fibral elements under tension limits displacement of the anatomic simulacra during use.

19. The anatomic simulacra according to claim 18, wherein the matrix comprises a composite material having a durometer proximate an exterior portion that is higher than a durometer proximate an interior portion.

20. The anatomic simulacra according to claim 18, wherein the plurality of fibral elements comprise a textile material or the plurality of fibral elements comprise at least one of a nylon material and a polyester material.
